(19) United States
(12) Patent Application Publication
(10) Pub. No.: US 2002/0064580 A1
(43) Pub. Date: May 30, 2002

(54) Cellulose-based food casings

(75) Inventors: Herbert Gord, Ingelheim (DE); Klaus-Dieter Hammer, Mainz (DE); Rainer Neeff, Wiesbaden (DE); Klaus Berghof, Rudolstadt-Schwarza (DE); Markus Eilers, Rudolstadt-Schwarza (DE); Reinhard Maron, Rudolstadt-Schwarza (DE)

Correspondence Address: HELLER EHRMAN WHITE & MCAULIFFE LLP, 1666 K STREET,NW, SUITE 300, WASHINGTON, DC, 20006, US

(73) Assignee: Kalle GmbH & Co. KG.

(21) Appl. No.: 09/908,742

(22) Filed: Jul. 20, 2001

(30) Foreign Application Priority Data
Jul. 22, 2000 (DE) 100 35 799.7

(51) Int. Cl. A23L 1/315

(52) U.S. Cl. 426/105

(57) ABSTRACT

The present invention relates to a cellulose-based food casing, manufactured with a spinning solution that comprises cellulose, N-methyl-morpholine-N-oxide, water, at least one additive that modifies the surface properties of the casing and at least one other additive that modifies its internal structure. The surface-modifying additive is preferably a protein, a protein derivative, a mono-, di- and triglyceride, a diketene with long-chained alkyl radicals, a wax and/or a paraffin. The casing may also optionally contain a fleece insert, and preferably has a tubular shape. The inventive casing is particularly suited for use as a sausage casing. Nonreinforced casings of the present invention are particularly suited for use as peelable casings for the production of sausage, while the fiber-reinforced casings are particularly suited for dry sausage.

### BACKGROUND OF THE INVENTION

1. Field of the Invention

The present invention relates to a cellulose-based food casing, as well as to a solution that comprises cellulose, N-methyl-morpholine-N-oxide (NMMO), water and additives that is particularly adapted for manufacturing food casings. Certain aspects of the present invention are directed to seamless tubular casings that are suited particularly as sausage casings as well as to methods for making food casings including sausage casings.

2. Description of Related Art

Cellulose is not soluble in conventional solvents. Cellulose does not have a specific melting point or range, but rather, it decomposes when heated and therefore it generally cannot be processed thermoplastically. Thus, cellulose is typically converted chemically when used for the production of food casings. These methods, however, are associated with a degradation of cellulose, i.e. the average degree of polymerization DP of cellulose is reduced, which in turn leads to reduced stress resistance of the casings manufactured therewith.

The viscose method is currently widely used for the production of casings. In connection with the viscose method, cellulose is converted with sodium hydroxide and subsequently with carbon disulfide. This way, a yellow-orange cellulose xanthogenate solution (viscose) is obtained, which is then extruded by a spinning nozzle. With the viscose method, fiber-reinforced casings can be produced as well. Generally, a fiber-like material B particularly preferred is hemp fiber paper B is shaped into a tube and then coated with viscose on the inside, outside or both (also described as interior, exterior or double viscosation). With the help of regenerating and rinsing baths, the cellulose xanthogenate is then regenerated into cellulose. The viscose method, however, requires technically complex and appropriately expensive fixtures for cleaning exhaust air and wastewater.

There is also a method for making casings known as the “Schweitzer's reagent method”, in which cellulose is complexed with Cu(NH₃)ₘ(OH)₂ and thus made soluble. This method as well is technically complex and pollutes the environment.

It was discovered in 1936 that cellulose is soluble in oxides of tertiary amines (DE 713 486); this discovery, however, was not pursued further until 30 years later. N-methyl-morpholine-N-oxide (NMMO) was identified as the a particularly suitable tertiary aminoxide. Cellulose dissolves in NMMO without undergoing chemical changes and no degradation of the cellulose chains takes place. The preparation of the appropriate spinning solutions is known for example as disclosed in DD 218 104; DD 298 789; U.S. Pat. No. 4,145,532; U.S. Pat. No. 4,196,282; and U.S. Pat. No. 4,255,300. From the spinning solution, threads can be manufactured through extrusion in a spinning bath as disclosed for example in DE-A 44 09 609; EP-A 574 870; and U.S. Pat. No. 5,417,909. WO 95/07811 and CA 2 149 218 also disclose a method for manufacturing cellulose tubular films based on the aminoxide method. The key to the aminoxide method disclosed therein is the cooling of the extruded film with coolant gas immediately beneath the annular gap of the extrusion die. The regeneration and cleaning of the NMMO is described in DD 274 435.

Since cellulose is not converted chemically in the NMMO method, the equipment requirements are less than with those required with the viscose method. A particular benefit of the aminoxide method relates to the fact that practically no gaseous or aqueous waste products are generated, and therefore waste air or water do not have to be treated in complex procedures. Therefore, the aminoxide method is gaining increasing importance.

EP-A 0 686 712 describes the production of cellulose fibers based on the NMMO spinning method. Here, a cellulose solution in water-containing NMMO is pressed through a spinning nozzle, guided across an air path into an NMMO-containing, aqueous regenerating bath, subsequently rinsed, post-treated and dried. The spinning solution and regenerating bath contain low-molecular, organic additives with nitrogen-containing groups. The additives are preferably amines, amides or other amino group-containing substances.

WO 95/35340 describes a method for producing cellulose blown films, in which NMMO-dissolved, non-derivatized cellulose is used.

The aminoxide method, however, also has disadvantages. The non-derivatized cellulose molecules have already been pre-oriented in the NMMO solution and are packed considerably more densely than with chemically modified (derivatized) molecules. Upon extrusion, the orientation of the cellulose in the longitudinal direction becomes even stronger. The threads produced this way thus have high stability in the longitudinal direction, however typically possess low stability in the crosswise direction. They have a strong splicing tendency under mechanical stress in wet conditions. Thus, such methods are not typically advisable for producing films or other shapes that must be able to endure stress in both the longitudinal and crosswise directions. Due to the compact arrangement of the cellulose chains, secondary plasticizers such as glycerin or other polyols may have to be included for the manufacture of the casings. But even with the incorporation of the secondary plasticizers, optimal flexibility cannot be achieved. Additionally, cellulose casings that are manufactured based on the aminoxide method almost always require additional interior impregnation, in order to provide the correct extent of adhesion between the casing and the filling. The type of interior impregnation that is used depends on the type of filling.

WO 97/31970 describes food casings based on cellulose hydrate, which have been manufactured in cellulose that has been dissolved in NMMO monohydrate. The spinning solution preferably contains additives, which make the casing more flexible. Particularly suited modifying compounds are starch, starch and cellulose derivatives, sucrose ester, alginic acid, alginates, chitosan, carrageenin, polyvinyl alcohol, polyvinyl acetate, polyacrylate, polyvinyl pyrrolidone, ethoxylated fatty acids and their salts, waxes and paraffins.

### SUMMARY OF THE INVENTION

An object of the present invention is therefore to provide a cellulose-based food casing, manufactured with a solution that comprises cellulose, N-methyl-morpholine-N-oxide, water and additives. The solution further comprises at least one additive which modifies the surface properties of the casing, and at least one other additive, that is capable of changing the internal structure of the casing.

The present invention further relates to a spinning solution comprising: cellulose, N-methyl-morpholine-N-oxide, water, a first additive comprising a protein, a protein derivative, a derivative of a mono-, di- or oligosaccharide, a mono-, di- and triglyceride, a diketene with long-chained alkyl radicals, a wax and/or a paraffin, and a second additive comprising starch, a starch derivative, cellulose, a cellulose derivative, a polysaccharide, alginic acid, an alginate, chitosan, polyvinyl alcohol, a polyvinyl acetate, a polyacrylate, polyvinyl pyrrolidone, a polyamide or a polyester, a copolymer with units of vinylpyrrolidone, a methylvinylether/maleic acid anhydride-copolymer, a fatty acid, and/or a fatty acid salt.

Additional objects, features and advantages of the invention will be set forth in the description which follows, and in part, will be obvious from the description, or may be learned by practice of the invention. The objects, features and advantages of the invention may be realized and obtained by means of the instrumentalities and combination particularly pointed out in the appended claims.

### DETAILED DESCRIPTION OF A PREFERRED EMBODIMENT

There was therefore a need in the art for casings that can be manufactured based on the aminoxide method available, but which do not display the above-described disadvantages. Particularly the surface properties of the casings needed to be improved so as to allow sufficient adhesion on the filling surface during the manufacturing and storage of the products such as sausage, while also permitting easy peeling at the same time. The casing should be able to be peeled so easily that additional interior preparation is only required in very few, very special applications (such as blood sausage). Casings should further be capable of being produced in a cost-effective and environmentally friendly manner. Additionally, the casing should be sufficiently flexible, yet resilient enough for use as sausage casings.

These and other objects can be achieved by adding specific additives to the cellulose/NMMO-hydrate solution, that produce a change in the surface of the casing, as well as other incorporating additional additives that effect a modification of the internal casing structure. Particularly, the latter additives allow the casings generally to become tougher and more flexible. Furthermore, the incorporation of the second additive raises the clip and shear stability of the casing. The surface properties relevant to casings of the present invention generally do not include surface topography, but generally include parameters such as surface tension and affinity to the filling, especially sausage filling.

As used herein, the term “cellulose based casings” refers to food casings that include at least 50% cellulose (or cellulose derivatives), often from 60 to 98% cellulose (or cellulose derivatives), in each case based on the total weight of the casing or on the weight of the components dissolved in the aqueous NMMO depending on the context used. The casing is preferably tubular, but can also be sheet-shaped or any other suitable shape as desired. Additionally, it can optionally contain fiber reinforcement. Fiber reinforcement typically involves the insertion of a sheet-shaped fiber-like material, e.g. a wet-stable hemp fiber paper. The fiber-like material in some embodiments can preferably have a weight of 15 to 28 g/m². The fiber-like material is generally formed into a tube, which is then coated on the inside and/or outside with the above-mentioned cellulose/NMMO-hydrate/additive solution. Homogeneously distributed fibers in the cellulose/NMMO-hydrate solution before the extrusion process generally are not included here in the term “fiber reinforcement,” particularly since such casings are difficult to manufacture. In particular, the die gap can frequently become clogged by the fibers.

The surface-modifying additives in some embodiments can comprise organic polymers. They can be natural polymers, derivatives of such natural polymers or synthetic polymers. Particularly suitable materials include proteins (such as gelatin, casein, wheat protein, soy protein), protein derivatives (e.g. gelatin or sodium or potassium caseinate that has been derivatized through a conversion with stearoylchloride), derivatives of mono-, di- or oligosaccharides, especially esters of sugar and fatty acids (such as ester from saccharose and straight-chained, saturated or unsaturated (C₁₂-C₂₄) fatty acids), mono-, di- and triglycerides (such as glycerin-monolaurate, which additionally also has fungicidal properties), diketenes with generally straight-chained, saturated (C₁₄-C₂₀) alkyl radicals (available e.g. under the term Aquapel®), waxes (such as beeswax, montan wax or carnauba wax) and/or paraffins. It is also possible to use several of the above additives simultaneously. Proteins in particular have an improving effect on the adhesion of the sausage filling. Additives with fat-like properties facilitate the peeling-off of the casing.

The percentage of surface-modifying additives preferably amounts to 0.2 to 50.0% weight, more preferably 0.3 to 15.0% weight, based on the weight of the cellulose in the solution or on the cellulose in the final casing. The amount of surface modifying additives included can vary depending on their individual effectiveness and the desired surface properties.

In addition to at least one surface-modifying additive, the spinning solution contains at least one other additive that may or may not be identical to the first one. The second additive is preferably capable of changing the internal structure of the cellulose casing. Preferably the two additives are not identical. Suitable structure-modifying additives are disclosed for example, in DE-A 196 07 953 [“DE-A '953”] incorporated herein by reference in its entirety. Particularly suited for the modification of the internal structure include additives such as starch, starch derivatives (particularly a starch ester or ether), cellulose, cellulose derivatives (particularly cellulose ether s such as methoxy- or ethoxycellulose or carboxymethyl cellulose), polysaccharides (such as xanthan gum [polysaccharide from the Xanthomonas campestris bacteria], carrageenin or carob bean gum), alginic acid, alginates, chitosan, polyvinyl alcohol, polyvinyl acetate, polyacrylates, polyvinyl pyrrolidone, copolymers with units of vinyl pyrrolidone, methylvinylether/maleic acid anhydride copolymers, aliphatic or aromatic polyamides (available e.g. under the term Grilltex® 1465 or Grilltex® 1466 from Ems Chemie AG) or polyester (particularly biologically degradable polyester such as polycaprolactone), fatty acids (such as stearic acid) or fatty acid salts (such as calcium stearate). The use of the instant structure-modifying additives partially affect the pliability and permeation of the casings. Additionally, they can be employed to impart a higher smoke permeability if desired.

The percentage of additives influencing the internal included preferably ranges from 0.1 to 50% weight, more preferably 0.5 to 25% weight, particularly preferably from 1 to 15% weight, in relation to the weight of the cellulose in the solution or on the weight of the cellulose in the final casing. As described in DE-A '953, these additives can be mixed with the spinning solution during manufacture of the casing or—like the surface-modifying additives—be added to the mixture in advance. The inclusion of the additional additives as instantly disclosed, in many cases even permit the spinning speed to be raised up to 30%.

The overall percentage of structure- and surface-modifying additives in some embodiments preferably is not more than 60% weight, advantageously in some embodiments, not more than 40% weight, in relation to the weight of the cellulose in the spinning solution or in the final casing. With a suitable selection of the type and percentage of the additives, the viscosity of the spinning solution can be varied within a wide range. In general, the viscosity is in a range of from 1,000 to 2,200 Pa·s. Depending on type and amount of the additives, the permeation may be up to 50% higher or up to 30% lower than the permeation of the pure cellulose casing.

The spinning solution preferably contains 5 to 15% weight, particularly preferred 6 to 12% weight, specifically 7 to 10% weight cellulose, in relation to the overall weight of the solution. The average degree of polymerization (DP) of the cellulose (or cellulose derivative) amounts to preferably 300 to 700, particularly preferred is 400 to 650. As a solvent, the spinning solution preferably contains 90.5 to 92.5% weight NMMO and 9.5 to 7.5% weight water. These parameters, together with the temperature, largely determine the viscosity and flow behavior of the spinning solution.

Methods for producing the spinning solution are generally known in the art. Any method can be used to form casings and spinning solutions of the present invention. Conventionally, in a suitable method, pulp is mixed with about a 60% weight aqueous NMMO solution at room temperature. The pulp is generally made of wood or cotton. With increasing temperature the water is then distilled off in a heated mixing container under a vacuum until the residue consists practically only of pulp and NMMO monohydrate. This is the case at a NMMO percentage of 87.7% weight, in relation to the overall weight of NMMO and water.

The NMMO: water ratio can be determined without difficulty by employing the refractive index. In the NMMO monohydrate, the pulp dissolves completely at a temperature of 85 to 105° C. and intense stirring. The solution created this way is then further stirred generally for several more hours at reduced pressure, with the water content of the solvent being reduced further to about 7.5 to 9.5% weight. The refractive index of the solution is then suitably from 1.4910 to 1.4930. The spinning solution is subsequently degassed, filtered and transferred into the spinning container. The mixing with the additives can take place at any random time before the extrusion process. It has proven particularly simple and useful to add the additives to the mixture at a time before extrusion, suitably when the pulp is mixed with the NMMO, or at any time thereafter, but before extrusion.

The additives are distributed substantially homogeneously in the spinning solution before it is extruded. Extrusion takes place preferably at a temperature of 85 to 105° C., particularly preferred at 90 to 95° C. In the production of tubular casings without a fiber paper insert, annular dies with a diameter of 14 to 1,200 mm, preferably 18 to 1,000 mm, and a width of the annular gap of 0.1 to 2.0 mm, preferably from 0.2 to 1.0 mm, are suitably used. The gap width is usually adjusted to the warpage. Warpage describes the quotient of the speed upon leaving the annular gap (outflow speed) and the speed at which the extruded tube is drawn off (draw-off speed). Warpage is generally at 0.2 to 2.4, preferably at 0.4 to 2.0, particularly preferred at 0.8 to 1.7. The outflow speed is 5 to 120 m/min, preferably 10 to 80 m/min, depending on the design of the equipment. It is also determined by the caliber. In a beneficial version, only little tensile force is applied to the extruded tube in the longitudinal direction, which is basically generated by its own weight. The extrusion process as a rule occurs downward, parallel to the draw-off direction.

In the air path, i.e. the distance between the annular gap and surface of the spinning bath, a first crosswise drawing of the casing can take place. The air path is preferably 1 to 50 cm, particularly preferred 2.0 to 30 cm. The air path also depends on the diameter of the tubular film after the drawing process. In contrast to the above mentioned WO 95/07811 incorporated herein by reference in its entirety, in connection with the present method, no measures are required for additional cooling in the air path and, accordingly, typically are not provided. The extruded tube cools only very little in the air path. Cross-orientation (desired is a casing in which the cellulose chains are oriented at a 451 angle on average to the longitudinal axis of the casing) is affected by gas pressure that is exercised from the inside and/or by the hydrostatic pressure of the interior bath if its level is higher than that of the surrounding exterior bath. Gas under pressure, e.g. pressurized air, can reach the interior of the nozzle through openings in the die body. Drawing in the crosswise direction increases the crosswise firmness of the tube considerably. Depending on warpage, the diameter of the blown tube is preferably up to 50%, more preferably up to 20%, particularly preferred up to 10% larger or smaller than immediately upon exiting the annular gap. In a preferred embodiment, the diameter of the blown tube deviates by −10% to +20%, particularly preferred by −5% to +20% from the diameter of the tube immediately upon exiting the annular gap. As described further below, a crosswise drawing process can also take place during drying when adjusting the interior pressure appropriately. The inventive casings, however, are preferably drawn crosswise one way or another since such a methodology maximizes the desired firmness and elongation properties. Appropriate selection of the type and percentage of additives allows shrinkage and firmness of the casing to be controlled. Cross-orientation is generally facilitated by the additives. One method and device for crosswise drawing processes of seamless film tubes on cellulose basis, which are manufactured based on the NMMO method, are also disclosed in DE-A 100 35 798, the content of which is incorporated herein by reference in its entirety.

Tube casings with fiber reinforcement (i.e., a fleece insert) can be drawn considerably less in the immediate die area. Longitudinal drawing in this case takes place between the paper unwinding device and lower spinning tub deflector roll. Cross-drawing is not possible in this area with inserted fiber paper because otherwise the paper overlap might slide or open up.

Upon entering the spinning bath, the diameter of the tube is reduced. The spinning solution affects the extruded tube from the outside and inside. Through appropriate devices in the die body, the spinning bath solution reaches also the interior of the cellulose tube. This causes the tube to firm up more quickly; at the same time it prevents the interior walls from bonding with each. The spinning bath itself is an aqueous solution, which contains 5 to 30% weight, preferably 10 to 20% weight NMMO. It can also contain additives that influence regeneration. Such additives however make the reprocessing of the NMMO more difficult. In order to achieve certain properties of the tube, it may prove useful to use an interior bath with a different composition than the exterior bath. Accordingly, the interior bath can also have a different density than the exterior bath. The temperature of the spinning bath is within the range of 0 to 50° C., preferably at 2 to 20° C.

The depth of the spinning bath is determined by the caliber of the cellulose tube, its wall thickness and desired resting period in the bath (spinning speed). In general, the depth should be selected so that when the tube lies flat on the deflector roll the edges that are generated are not damaged. In the case of a tube of a caliber 20, which has a wall thickness of 0.5 mm immediately upon exiting the annular gap and is guided through the bath at a speed of 20 m per minute, the spinning bath has a depth of about 3 m.

In order to further firm up the flat tube, it then passes several regenerating and washing tubs. In the regenerating tub, the percentage of NMMO decreases. The NMMO content is determined by the length of the regenerating distance, the spinning speed, the caliber of the tube and quantity of water that is added. Additionally, it has proven favorable to increase the temperature from one regenerating tub to the next, up to about 60 to 70° C. in the last tub. The NMMO in the tube is then rinsed away even more quickly.

This so-called regenerating tub is then followed by rinsing tubs filled with water, where the last traces of NMMO are washed out of the tube. The temperature of these tubs is 15 to 70° C., preferably 40 to 60° C.

The used aqueous NMMO solutions gained from the spinning, regenerating and rinsing baths can be cleaned particularly easily with ion exchange columns. The water can be pulled out in a vacuum until the NMMO concentration reaches 60% weight again. This NMMO solution can then be used again for the production of spinning solutions. The NMMO is thus nearly regained quantitatively.

Usually this is followed by a so-called plasticizer tub. It contains an aqueous solution of a plasticizer for cellulose. Suitable plasticizers are polyols and polyglycols, particularly glycerin. The aqueous solution contains 5 to 30% weight, preferably 6 to 15% weight plasticizer. Beneficially the temperature of the plasticizer solution is 20 to 80° C., preferably 30 to 70° C.

If the casing already contains the above-described structure-modifying additives, then an additional softening process with secondary plasticizers is frequently not required. This is generally the case when the percentage of structure-modifying additives amounts to more than 8% weight, in relation to the weight of the cellulose.

After that the tubes are run through a hot air dryer in the blown state. It is useful to dry them at decreasing temperatures (from about 150° C. at the entrance to about 80° C. at the exit of the dryer). A (possibly additional) cross-orientation can be achieved if necessary with appropriately increased interior pressure during the drying process. Otherwise, the tube is blown to the original caliber during drying in order to keep the caliber unchanged once it is achieved. During the drying process, the swelling value drops to 130 to 180%, preferably to 140 to 170%, depending on the drying conditions, type and percentage of the additives and glycerin content. The tube is then conditioned until the water content is 8 to 20, preferably 16 to 18% by weight, in relation to the overall weight of the tube. Subsequently, it can be flattened with the help of a set of squeeze rollers and be wound.

Depending on the caliber, the finished tubes have a weight of 30 to 150 g/m², preferably 35 to 120 g/m², at a glycerin content of 20 to 22% by weight and a water content of 8 to 10% by weight, each in relation to the overall weight of the tube. The square meter weight generally rises with increasing caliber. The bursting pressure is also dependent upon the caliber (smaller calibers have a higher bursting pressure). In the case of a tube with a caliber of 16 to 30 mm, the bursting pressure is about 60 to 40 kPa, in the case of a caliber of 30 to 50 mm it is about 40 to 24 kPa, in the case of a caliber of 50 to 140 mm it is about 35 to 15 kPa. Bursting pressure is measured in the wet state. Expansion during filling and/or the filling caliber depends on the elastic expansion degree and the diameter of the spinning nozzle. Expansion generally amounts to up to 10%, however, it can be up to 100% or more, preferably, however, +10 to +80%, for special types without fiber paper inserts.

In the case of fiber-reinforced casings, the areal weight of the fiber paper insert and the weight of the applied cellulose rises with increasing caliber. Such casings have a bursting pressure of about 200 kPa at a caliber of 30 mm, or about 40 kPa at a caliber of 180 mm.

Beyond that, the invented tubular casing can be equipped with an impregnation or coating on the interior and/or exterior side, depending on the usage of the casing, e.g. a liquid smoke impregnation, an easy-peel interior treatment, an adhesion or separation treatment. The same, of course, also applies to the tubular films with fiber reinforcement and for flat films.

A considerable advantage of the invented surface- or tubular films is the even structure and thus even density that is created during the regenerating process. By contrast, films that are produced based on the viscose method have a density gradient (high density on the surface, low density in the interior).

The tubular films according to the present invention are preferably used as sausage casings, particularly as peelable casings B in the design without fiber reinforcement B in the production of Frankfurters. Apart from that, they can also be used as membranes for various purposes, e.g. haemodialysis. By cutting the tubes open, flat films may be obtained as well.

The following examples serve the purpose of a more detailed explanation of the invention. Percent values provided are weight percentages, unless specified otherwise.

### EXAMPLE 1

### Comparative Example

4 kg ground chemical wood pulp (sulfite cellulose MoDo Dissolving from MoDo Company) with an average degree of polymerization of 600 (determined by the the Cuoxam method) was mixed into 51 kg of a 60% NMMO solution. The pH value of the mixture was then adjusted to a value of 11 by adding NaOH. Water was then distilled off in a vacuum at rising temperature while stirring and heating the mixture until the monohydrate was obtained at an NMMO content of 87.7% in relation to the overall weight of water and NMMO (as recognized by the refractive index of 1.4820). During this phase, which lasted about 4 hours, the vacuum was kept at 10 to 16 torr. After stirring the mixture another 2 to 3 hours at about 85 to 95° C., the pulp was completely dissolved. In order to allow less water to evaporate, the vacuum was set at 200 torr during this time. The refractive index was about 1.4884.

The spinning solution prepared this way was then extruded at a temperature of 90° C. through an annular gap die with a gap diameter of 20 mm and a gap width of 0.5 mm. The tube passed initially a 10 cm long air path at a speed of 20 m/min, where it was cross-drawn with hydrostatic pressure. A 15% aqueous NMMO solution that was cooled down to 5° C. was fed into the interior of the tube and replaced on a constant basis, acting as the interior regenerating bath. Afterward it passed a regenerating path distance of 3 m, where it was deflected after half the distance. The composition and temperature of the spinning bath were identical to those of the interior bath. The tube was drawn crosswise so far that its flat width was 30 mm upon leaving the spinning tub. The edges were not damaged.

The tube then passed 4 regenerating tubs with 8 deflection rolls each on the top and bottom, a bath depth of 1 m and an air path of 2 m. At the end of the last tub water was introduced, which was guided in a reverse direction flow. At the exit of the first tub the NMMO content was maintained at 12 to 15% this way. The temperature rose up to 60 to 70° C. in the last tub. Upon passing through this regenerating distance, residues of NMMO were rinsed out of the tube in 4 rinsing tubs. The temperature in these tubs was also 60 to 70° C. Finally, the tube was guided through a plasticizer tub, which contained a 10% glycerin solution with a temperature of 60° C. The flat width was still 20 mm upon leaving the glycerin tub. The tube was then dried with hot air between 2 sets of squeeze rollers. The dryer was equipped with several zones with decreasing temperatures. The zone at the entrance had a temperature of 120° C., the one at the exit of 80° C. After that the tube was moistened until its water content was 8 to 12% (in relation to the overall weight of the tube) and wound. The bursting pressure of this tube was 52 kPa, its water inhibition value 130%, its flat width 30 mm. It was then moistened to 16 to 18% and bunched into beads.

On a casing that was produced this way an easy-peel impregnation material was sprayed onto the internal surface during the shirring process.

The sticks formed in the shirring process were put on an automatic filling machine (FrankAMatic®), filled with sausage meat emulsion, boiled and smoked. After that the casings were peeled with an automatic device. The casing without additional interior impregnation could not be peeled without difficulty. Upon leaving the peeling device, pieces from the sausage surface were still attached to the casing. On the casing with the easy-peel impregnation this problem did not occur; the peeling behavior was good.

### EXAMPLE 2

A spinning solution produced in accordance with example 1 with a cellulose content of 9% in relation to the overall weight of the solution, however, which, contrary to example 1, was mixed with 10% glycerin monolaurate (GML) and 0.5% carboxymethyl cellulose (CMC) in relation to the overall weight of the originally solid components dissolved in the spinning solution (hereinafter designated as “overall weight of the solid matter”), was spun as described above. The surface tension of the casing manufactured this way was reduced considerably (see table below). The casing without easy-peel impregnation could be peeled without difficulty from the sausage filling with an automatic peeling device.

### EXAMPLE 3

Example 2 was repeated but instead of GML and CMC, gelatin and starch were used as additives. The weight percentage of gelatin was again 10%, that of the starch was 1%, in relation to the overall weight of the solid matter. The spinning solution modified this way was used to produce a casing with a caliber of 40 mm. This casing displayed good adhesion and peeling properties for salami filling.

### EXAMPLE 4

Example 2 was repeated but instead of GML and CMC, GML and carboxymethyl starch (CMS) were used as additives. The weight percentages of GML and CMS were 5%, respectively, in relation to the overall weight of the solid matter. The casing manufactured with this modified spinning solution displayed a reduced surface tension and increased permeation, which made it more permeable for smoke. The peeling behavior was good, even without easy-peel treatment.

### EXAMPLE 5

Example 2 was repeated but instead of GML and CMC, sodium caseinate and carob bean gum were used as additives. The weight percentages of sodium caseinate and carob bean gum were 5%, respectively, in relation to the overall weight of the solid matter. The casing produced with this modified spinning solution displayed a reduced surface roughness and increased permeation, which made it more permeable for smoke. Filling adhesion was improved compared to a pure cellulose casing. Therefore this casing could be used very well for hard sausage.

### EXAMPLE 6

Example 2 was repeated but instead of GML and CMC, gelatin and sodium caseinate were used as additives. The weight percentages of gelatin and sodium caseinate were 5%, respectively, in relation to the overall weight of the solid matter. From this modified spinning solution a tubular casing was obtained that had a reduced surface tension, roughness and permeation. This lead to very good filling adhesion and very good aging properties. The casing was therefore suited very well for hard sausage.

### EXAMPLE 7

Example 2 was repeated but instead of GML and CMC, gelatin, carboxymethyl starch and sodium caseinate were used as additives. The weight percentages of gelatin, CMS and sodium caseinate were 3.33%, respectively, in relation to the overall weight of the solid matter. From this modified spinning solution, a casing was obtained whose surface tension and roughness were reduced. Permeation was increased. This lead to improved smoke permeability and improved peeling ability for smoked sausage to be heated in water.

The following table summarizes the properties of the casings that were produced in accordance with the examples 1 through 7.

TABLE 1

| Solid Matter in Spinning | | Viskosity | Surface | Rough- | Permeation |
|---|---|---|---|---|---|
| Solution | | ηₒ | Tension | ness | [l/m² · d] |
| Type | Percentage | [Pa · s] | [mN/m] | [nm] | at 40 bar |
| Cellulose | 10.0% | 2.500 = | 48 = | 63.5 = | 150 = |
| | | 100% | 100% | 100% | 100% |
| Cellulose | 8.95% | 50% | 70% | 250% | 80% |
| GML | 1.00% | | | | |
| CMC | 0.05% | | | | |
| Cellulose | 8.90% | 60% | 85% | 90% | 70% |
| Gelatin | 1.00% | | | | |
| Starch | 0.10% | | | | |
| Cellulose | 9% | 75% | 80% | 75% | 120% |
| GML | 0.5% | | | | |
| CMS | .5% | | | | |
| Cellulose | 9% | 150% | 100% | 80% | 150% |
| Na-caseinate | 0.5% | | | | |
| Carob Bean | 0.5% | | | | |
| Gum | | | | | |
| Cellulose | 9% | 60% | 85% | 70% | 80% |
| Gelatin | 0.5% | | | | |
| Na-caseinate | 0.5% | | | | |
| Cellulose | 9% | 70% | 90% | 85% | 130% |
| CMS | 0.33% | | | | |
| Gelatin | 0.33% | | | | |
| Na-caseinate | 0.33% | | | | |

Apart from the tubular films described in examples 1 through 7, flat films in the manual production method were also prepared. For this, cellulose/NMMO-hydrate solutions were mixed with various additives. The solutions were then applied with a hand scraper as a thin coating onto a glass plate that had been preheated to about 90 to 100° C. Afterward, the glass plate with the applied coating was immersed into about a 15% aqueous NMMO regenerating bath. The film that was dissolved from the base was then rinsed several times until it was practically free from NMMO residues and immersed into about a 5% aqueous glycerin solution. The flat film was dried on a tenter frame until it had a residual humidity of 8 to 10%. For the purpose of comparison, a film without additives was produced. In Table 2 below, the compositions of the individual solutions, their viscosity and the surface properties (roughness and surface tension on the outer side, i.e. the side facing away from the base originally) of the film that was produced this way have been summarized.

| | | | Viscosity of | | | Roughness | Surface |
|---|---|---|---|---|---|---|---|
| | Solid Matter in | | Spinning | | Thickness | Outside | Tension |
| Example | Spinning Solution | | Solution | Areal Weight | of Film | Rmax | Outside |
| No. | Type | Percentage | ηₒ [Pa · s] | [g/m²] | [μm] | [μm] | mN/m |
| 8 | Cellulose | 10% | 2488 | 77.9 | 53 | 6.35 | 48 |
| 9 | Cellulose | 8.95% | 1287 | 66.2 | 44 | 15.87 | 48 |
| | Beeswax | 1.00% | | | | | |
| | Starch Acetate | 0.05% | | | | | |
| 10 | Cellulose | 8.94% | 1425 | 70.0 | 42 | 5.81 | 41 |
| | Gelatin | 1.00% | | | | | |
| | CMC | 0.06% | | | | | |
| 11 | Cellulose | 8.90% | 1348 | 64.3 | 41 | 15.68 | 35 |
| | GML | 1.00% | | | | | |
| | Starch | 0.06% | | | | | |
| 12 | Cellulose | 8.80% | 1462 | 73.9 | 46 | 3.54 | 41 |
| | Na-caseinate | 1.00% | | | | | |
| | Hydroxyethyl | 0.20% | | | | | |
| | Cellulose | | | | | | |

The table shows that the surface properties are influenced considerably by the additives. Depending on the type of the additive, roughness and surface tension increase or decrease. This allows the casing to be adjusted well to the respective filling, particularly adhesion and peeling abilities can be adjusted.

Apart from the tube and flat films without fiber reinforcement, tubular films with fiber fleece inserts were manufactured. The following spinning solutions were used:

a) Spinning solution with addition of 10% gelatin and 2% CMC, each in relation to the weight of cellulose

Into 51 kg of a 60% aqueous NMMO solution, which had been adjusted to a pH of 11 by adding NaOH, we stirred 250 g conventional gelatin. To the suspension obtained this way, we then added 2.5 kg ground chemical wood pulp (sulfite cellulose MoDo Dissolving with a Cuoxam-DP of 550 MoDo Company) and 50 g carboxymethyl cellulose (CMC C30 from Clariant GmbH). Water was then distilled off at reduced pressure (25 mbar) at rising temperature while heating and stirring the mixture until the percentage of NMMO in the solvent was at 87% (corresponds to NMMO monohydrate). Afterward, it was stirred for 2 hours at a temperature of 90° C. and a pressure of 200 mbar. The pulp was then completely dissolved. The solution had a refractive index of 1.4805, its zero shear viscosity at 85° C. was 92 Pa·s.

b) Spinning solution with addition of 10% GML and 15% starch, reach in relation to the weight of cellulose

Into 40 kg of a 76% aqueous NMMO solution we stirred 580 g GML paste (42% dry matter content) at a temperature of 60° C., which caused the GML to melt. Afterward, 2.5 kg ground chemical wood pulp (sulfite cellulose MoDo Dissolving, as under a)), and 37.5 g starch were added. Water was then distilled off at reduced pressure (25 mbar) at rising temperature while heating and stirring the mixture until the percentage of NMMO in the solvent was at 87%. Afterward, it was stirred for 2 hours at a temperature of 90° C. and a pressure of 200 mbar. The pulp was then completely dissolved. The solution had a refractive index of 1.4820, its zero shear viscosity at 85° C. was 83 Pa·s.

### EXAMPLE 13

### Fiber-Reinforced Casing

As described in DE-A 198 43 723, a fiber fleece with a weight of 17 g/m² was formed into a tube of caliber 40 and coated on the outside with the spinning solution described under a), containing cellulose and gelatin. The additional manufacturing steps correspond to those mentioned in Example 1.

The casing manufactured this way had a reduced surface tension. Bursting pressure of the casing (in wet state) was 105 kPa. Statistical expansion in the moistened state was 44.5 mm with an interior pressure of 42 kPa. The gelatin caused good filling adhesion, even without additional interior treatment. During aging, the casing shrunk with the filling and was easy to peel.

### EXAMPLE 14

### Fiber-Reinforced Casing

Example 13 was repeated with the deviation that the fiber fleece, which was formed into a tube with caliber 40, was coated with the spinning solution described under b), containing cellulose and GML. Bursting pressure of the casing (in wet state) was 102 kPa. The statistical expansion in the moistened state was 44.2 mm with an interior pressure of 42 kPa; the surface tension was 38 dyn/cm. After boiling, filling and smoking of the Bologna-type filling, the casing was easy to peel.

Additional advantages, features and modifications will readily occur to those skilled in the art. Therefore, the invention in its broader aspects is not limited to the specific details, and representative devices, shown and described herein. Accordingly, various modifications may be made without departing from the spirit or scope of the general inventive concept as defined bye the appended claims and their equivalents.

The priority document, German Patent Application No. 100 35 799.7, filed Jul. 22, 2000 is incorporated herein by reference in its entirety.

As used herein and in the following claims, articles such as “the”, “a” and “an” can connote the singular or plural.

All documents referred to herein are specifically incorporated herein by reference in their entireties.

What is claimed is:

1. A food casing prepared using a spinning solution comprising:
cellulose,
N-methyl-morpholine-N-oxide,
water,
at least one first additive that is capable of modifying the surface properties of the casing, and
at least one second additive that is capable of modifying the internal structure of said casing.

2. A food casing in accordance with claim 1, wherein the first additive comprises a protein, a protein derivative, a derivative of a mono-, di- or oligosaccharide, a mono-, di- and triglyceride, a diketene with long-chained alkyl radicals, a wax and/or a paraffin.

3. A food casing in accordance with claim 2, wherein the percentage of the first additive is 0.2 to 50.0% weight, based on the weight of cellulose in said spinning solution.

4. A food casing in accordance with claim 1, wherein second the additive comprises starch, a starch derivative, cellulose, a cellulose derivative, a polysaccharide, alginic acid, an alginate, chitosan, polyvinyl alcohol, a polyvinyl acetate, a polyacrylate, polyvinyl pyrrolidone, a polyamide or a polyester, a copolymer with units of vinylpyrrolidone, a methylvinylether/maleic acid anhydride-copolymer, a fatty acid, and/or a fatty acid salt.

5. A food casing in accordance with claim 1, wherein the percentage of the second additive is from 0.1 to 50% weight, based on the weight of the cellulose in said spinning solution.

6. A food casing in accordance with claim 1, wherein said casing is tubular.

7. A food casing in accordance with claim 1, wherein said casing comprises a fleece insert.

8. A food casing in accordance with claim 1, wherein the spinning solution comprises 5 to 15% weight cellulose, in relation to the overall weight of said spinning solution.

9. A food casing in accordance with claim 1, wherein the cellulose has an average degree of polymerization DP of 300 to 700.

10. A food casing in accordance with claim 1, wherein the spinning solution comprises at least one solvent, 90.5 to 92.5% weight N-methyl-morpholine-N-oxide and 9.5 to 7.5% weight water, based on the overall weight of said at least one solvent.

11. A method for preparing a food casing in accordance with claim 1, comprising extruding said spinning solution at a temperature of 85 to 105° C., through a annular gap die with a gap width of 0.1 to 2.0 mm.

12. A method according to claim 11, wherein an air path between the annular gap and the surface of the spinning solution is 1 to 50 cm.

13. A sausage casing comprising a food casing according to claim 1.

14. A spinning solution comprising:
cellulose,
N-methyl-morpholine-N-oxide,
water,
a first additive comprising a protein, a protein derivative, a derivative of a mono-, di- or oligosaccharide, a mono-, di- and triglyceride, a diketene with long-chained alkyl radicals, a wax and/or a paraffin, and
a second additive comprising starch, a starch derivative, cellulose, a cellulose derivative, a polysaccharide, alginic acid, an alginate, chitosan, polyvinyl alcohol, a polyvinyl acetate, a polyacrylate, polyvinyl pyrrolidone, a polyamide or a polyester, a copolymer with units of vinylpyrrolidone, a methylvinylether/maleic acid anhydride-copolymer, a fatty acid, and/or a fatty acid salt.

15. A spinning solution according to claim 14, wherein said solution is adapted to be used as a precursor in the manufacture of a food casing and said first additive is capable of modifying the surface properties of said casing and said second additive is capable of modifying the internal structure of said casing.

16. A method for preparing a food casing as claimed in claim 1, comprising:
crosswise drawing said spinning solution to form a film tube.
